(19) United States
(12) Patent Application Publication
(10) Pub. No.: US 2006/0038386 A1
(43) Pub. Date: Feb. 23, 2006

(54) Side air bag with directional expansion belt

(75) Inventors: Koji Shibayama, Nishikasugai-gun (JP); Yuji Sato, Nishikasugai-gun (JP); Motoaki Naruse, Nishikasugai-gun (JP); Satoshi Mabuchi, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/185,960

(22) Filed: Jul. 21, 2005

(30) Foreign Application Priority Data
Jul. 26, 2004 (JP) 2004-217610

(51) Int. Cl. B60R 21/16

(52) U.S. Cl. 280/730.2

(57) ABSTRACT

A side air bag is expanded by gas discharged from an inflator between a side body of a vehicle and a vehicle front seat. The air bag is fixed with a case in a seat back of the front seat, and expands in a vehicle frontward direction. A belt is sewn to the air bag at a portion where the air bag is fixed to the case and at a seamed front portion of the air bag. The belt creates a tensile force on the air bag that restricts frontward directional deviation of the air bag during expansion.

### CROSS REFERENCE TO RELATED APPLICATION

This application is based on and incorporates by reference Japanese Patent Application No. 2004-217610, which was filed on Jul. 26, 2004.

### BACKGROUND OF THE INVENTION

The present invention relates to side air bags, and more particularly to a side air bag with a directional expansion belt that causes the air bag to expand in a predetermined direction.

A conventional side air bag is designed to expand within a vehicle passenger compartment in an area between a vehicle door and a vehicle passenger seat when the vehicle is involved in a collision and a side impact force is exerted on the side body of the vehicle. The air bag absorbs the shock caused by the side impact force, and protects the head region, the thoracic region and the hip region of the passenger.

At the time of the collision, a high pressure gas discharged from an inflator quickly expands the air bag. The air bag must also expand in a controlled manner based on its position within the vehicle passenger compartment and its shape. However, as the pressure of the discharged gas increases upon air bag deployment, it is difficult to control the expansion of the air bag because the high pressure gas tends to cause the air bag to expand in unintended directions. Thus, it is important to control the directional expansion of the air bag.

Certain prior art air bag devices are designed to control air bag expansion. For example, one such prior art air bag includes an integral strap for restricting expansion of the air bag during deployment. However, such an air bag is used as a driver's side air bag. Because the air bag for the driver is stably mounted in a steering wheel at a base part of the air bag, the air bag is not displaced significantly during expansion. Also, expansion of the air bag is not restricted by the vehicle compartment itself due to the relatively large amount of open space around the steering wheel. Therefore, directional expansion control of the air bag during expansion is less critical. However, form expansion control of the air bag is more important because the gas used to expand the air bag during air bag deployment concentrates at the center of the air bag, thereby causing the center of the air bag to expand more rapidly than other portions of the air bag. Therefore, a restricting portion or a restricting member is used to restrict the expansion of the air bag at the center thereof.

On the other hand, the importance of both directional and form expansion control of the air bag during expansion increases for a side air bag device. Typically, an end base of the side air bag device is fixed in a passenger side seat back to frontwardly expand the air bag from the side of the passenger seat. Because the gas used to expand the air bag concentrates at the front end of the air bag during expansion, it is difficult to expand the air bag toward the head region and/or the hip region. Instead, the side air bag tends to expand toward the side and front of the vehicle within the vehicle passenger compartment during deployment, and tends to be forwardly inclined at the end base of the air bag as a result of its weight and as a result of the inertia created by the gas used to expand the air bag. The side air bag is also restricted during deployment due to the limited amount of space between the vehicle door and the passenger seat in which the air bag expands. Consequently, it is difficult to provide accurate positional expansion control of a side air bag.

### SUMMARY OF THE INVENTION

An object of the invention is to overcome the above mentioned limitations. The side air bag of the present invention enables directional and form control of the air bag expansion control during air bag expansion.

The side air bag of the present invention includes an air bag that is fixed in a seat back, that is formed to have either an upwardly or downwardly protruding shape, that is expanded in a frontward direction from the seat back by gas discharged from a gas generator. A belt is formed from nylon and is sewn on a portion of the air bag where the air bag is fixed to the vehicle and on a peripheral part of a front side of the air bag. The belt provides a tensile force to the air bag that restricts frontward deviation from an intended direction of expansion of the air bag during expansion.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a side view of an air bag of a first embodiment in an expanded condition;

FIG. 2 is a cross sectional side view of the air bag of the first embodiment;

FIG. 3 is a cross sectional view of the air bag through line 3-3 in FIG. 2;

FIG. 4 is a side view of the air bag of a second embodiment in an expanded condition;

FIG. 5 is a cross sectional side view of the air bag of the second embodiment; and

FIG. 6 is a cross sectional view of the air bag through line 6-6 in FIG. 5.

### DETAILED DESCRIPTION OF THE PREFERRED EMBODIMENTS

### First Embodiment

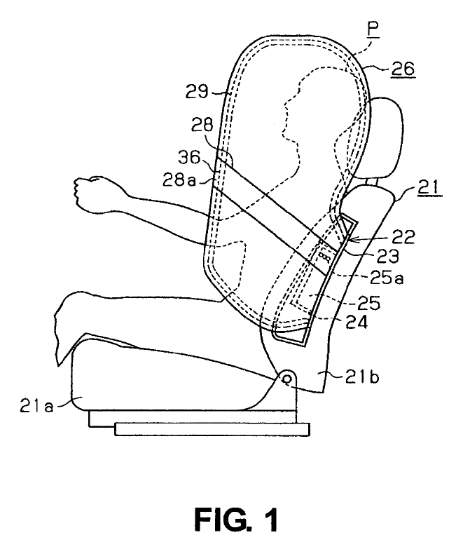

Referring to FIG. 1, a first embodiment of the present invention will be now explained. In this description, the term “frontward direction” is defined as the direction of travel of a vehicle. Unless extra explanation is added, directions are based on reference to the traveling direction of a vehicle.

FIG. 1 shows a front seat 21 that is fixed on a left side of a vehicle. The front seat 21 includes a stool 21a and a seat back 21b. A side air bag device 22 assembled in a case 23 is mounted in the outside (left side) of the seat back 21b of the front seat 21. The side air bag device 22 is fixed corresponding to the position of a door (not shown) which forms a part of the vehicle body side. FIG. 1 shows only the front seat 21 on the left side of the vehicle, but the front seat 21 on the right side of the vehicle also includes the air bag device 22 in the right side of the front seat 21.

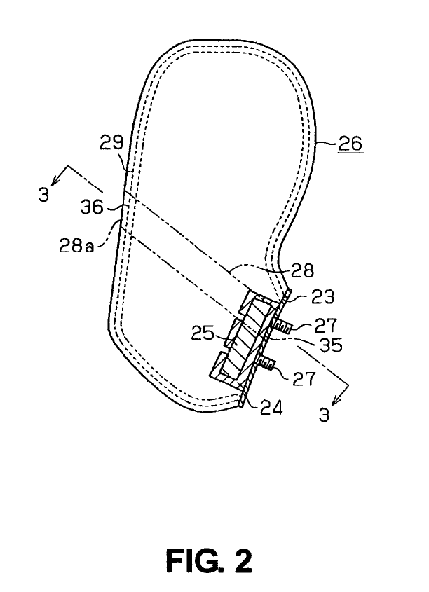

As shown in FIGS. 1 and 2, the side air bag device 22 includes a tube-like retainer 24, a cylindrical inflator 25 that is crimped in the retainer 24 and used as a gas generator, and an air bag 26 that covers the retainer 24 and the inflator 25. The air bag 26 is wedged between the retainer 24 and the case 23 and is fixed by a pair of bolts 27 on the case 23. The inflator 25 includes a gas generating agent for generating gas to expand the air bag 26. The upper portion of the inflator 25 includes discharge openings 25a for discharging gas generated by the gas generating agent. The inflator 25 is electrically connected to a shock sensor (not shown) for sensing a shock to the body side portion of a vehicle. When the vehicle is involved in a collision and a side impact force is exerted on the side body of the vehicle, the gas generating agent generates a gas according to a detected signal from the shock sensor, and the air bag 26 is expanded by the gas as the gas is discharged through the discharge openings 25a into the air bag 26.

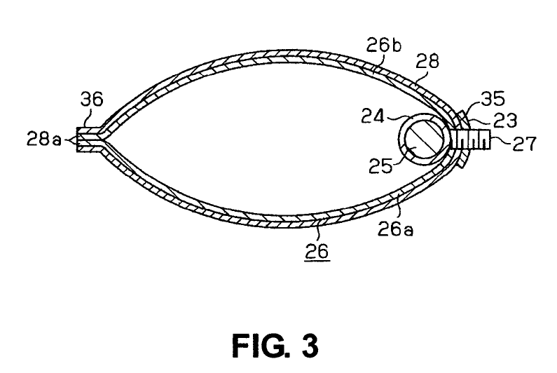

As shown in FIGS. 1-3, the air bag is fixed, or anchored, in the case 23, which is also referred to as a fixing portion. The air bag 26 of the first embodiment forms a shape that, when expanded, covers a head region and a thoracic region of a passenger P, and expands between the body side of the vehicle and a location of the passenger P. The air bag 26 is formed by two pieces of foundation cloth 26a, 26b that are sewn together around respective peripheries thereof. The air bag 26 has a flat, generally planar shape and an upwardly protruding shape that corresponds to the head portion of the passenger P when the air bag is viewed in a non-deployed, unfolded state. The air bag 26 is folded and housed in the case 23, and when deployed is frontwardly expanded from the case 23.

A belt 28 is formed on and around a peripheral surface of the air bag 26. The belt 28 is made from the same material as the air bag 26 such as, for example nylon 6 or nylon 6-6. Both edges of the belt 28 are sewn together at a seamed front portion 29 of the air bag 26. A center portion 35 of the belt 28 is fixed on the case 23 together with the air bag 26 by bolts 27. A portion where the belt 28 is fixed with the air bag 26 will be referred to as a junction portion 28a, and the seamed front portion 29 where both edges of the belt 28 are sewn to each other will be referred to as a seamed belt portion 36. The seamed belt portion 36 is located above the inflator 25 in the direction of the head of the passenger P. Thus, the belt 28 when expanded is oriented upwardly from the case 23 to the seamed belt portion 36.

The belt 28 is not sewn to the air bag 26 except at the junction portion 28a and the center portion 35. Therefore, only these two portions of the belt 28 are fixed on the air bag 26. Thus, a tensile force is added on the belt 28 between the junction portion 28a and the center portion 35 when the air bag 26 is expanded.

The tensile force strains the seamed belt portion 36 toward the case 23. The length of the belt 28 is no more than twice distance between the seamed belt portion 36 and the case 23 when the air bag is viewed in a non-deployed, unfolded state. If the length of the belt 28 is much less than the distance between the seamed potion 36 and the case 23, the seamed belt portion 36 does not reach a preferable position when the air bag 26 is expanded. If the length of the belt 28 is excessively longer than twice the distance between the seamed belt portion 36 and the case 23, the tensile force for restricting the position of the air bag 26 cannot be obtained during expansion. The preferable length of the belt 28 is a little shorter than twice the distance between the seamed belt portion 36 and the case 23 when the air bag is viewed in a non-deployed, unfolded state. For example, the preferable length of the belt 28 is 1.6≦BELT LENGTH<2.0 times as long as the distance between the seamed belt portion 36 and the case 23.

Referring again to FIGS. 1-3, expansion of the side air bag device 22 will be explained. The side air bag 26 is expanded at the side of the passenger P when the sensor of the vehicle detects the aforementioned side collision. At that time, the air bag 26 is frontwardly and upwardly expanded from the case 23. As the force of the gas discharged from the inflator 25 tends to expand the upper portion of the air bag 26 in a frontward direction, deviation from a preferable expanded position may occur. The seamed belt portion 36, however, is pulled back toward the case 23 by the tensile force created by the belt 28 when the air bag 26 is expanded. Thus, the frontward deviation from the preferable position is restricted. Therefore, as the belt 28 can control the expanded position of the air bag 26, the passenger P is preferably protected.

According to the airbag device of the first embodiment, the air bag 26 can be expanded without deviation from its preferable expanded position because the seamed belt portion 36 is pulled back toward the case 23 by the tensile force created by the belt 28. Therefore, as the belt 28 can control the expanding position of the air bag 26, the passenger P is preferably protected.

Because the belt 28 is sewn on the surface of the air bag 26, the belt 28 can preferably control the expanding position of the air bag 26 in a restricted space. Because the air bag 26 is formed to expand upwardly from the inflator 25, the expanding force created by the gas discharged from the inflator tends to cause the upper portion of the air bag 26 to expand in a direction toward the front of the vehicle. However, because the seamed belt portion 36 of the belt 28 is located upwardly relative to the inflator 25, the seamed belt portion 36 is pulled back toward the case 23 by the tensile force created by the belt 28 during expansion of the air bag. Therefore, the expanding position of the air bag 26 can be preferably controlled.

### Second Embodiment

The air bag device according to the second embodiment of the present invention will now be explained primarily by discussing the differences between the first embodiment and the second embodiment.

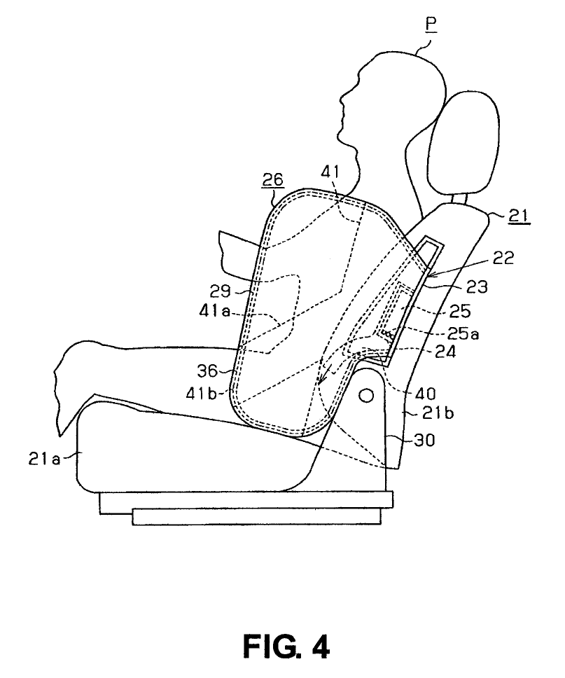

As shown in FIG. 4, an air bag 26 according to the second embodiment is formed to be expanded between the body side of the vehicle and a passenger P, especially from thorax region to the hip region of the passenger P. A front seat 21 includes a seat back 21b and a stool 21a. The seat back 21b can be folded to overlap the stool 21a, and the seat back 21b can be used as a table. A hinge 30 for folding the seat back 21b projects at the lower side of the seat back 21b. Therefore, a case 23 and a side air bag device 22 are fixed above the hinge 30.

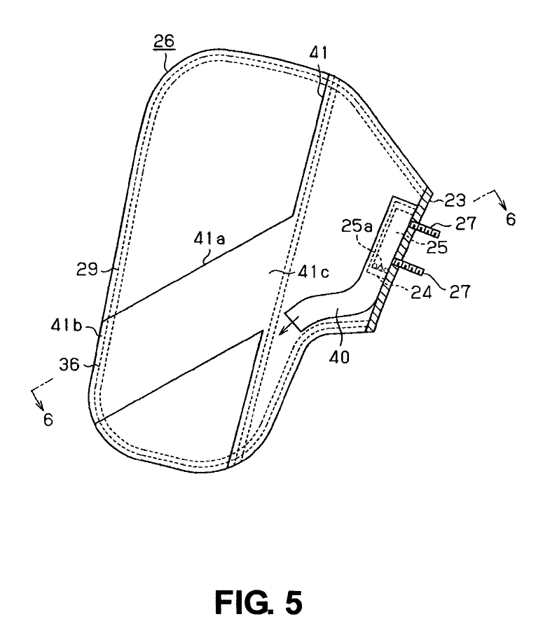

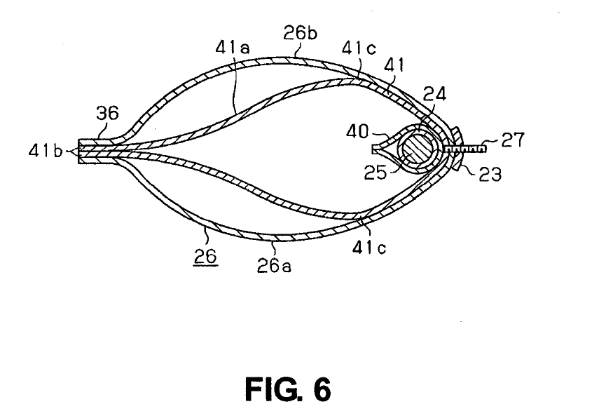

As shown in FIGS. 5 and 6, an inner tube 40 that is located within the air bag 26 completely covers a retainer 24. The inner tube 40 is placed between the retainer 24 and the case 23 and is fixed with the air bag 26 by bolts 27. The upper end of the inner tube 40 is located above the upper end of the retainer 24, and the lower end of the inner tube 40 extends to the lower portion of the air bag 26 corresponding to the hip region of the passenger P. A discharge opening 25a is formed on a lower side of the inflator 25. Gas discharged from the inflator 25 is conducted by the inner tube 40 to the lower portion of the air bag 26 bypassing the hinge 30 (FIG. 4).

The air bag 26 has a flat, generally planar shape and has a downwardly protruding portion, which corresponds to the hip region of the passenger P, when the air bag is viewed in a non-deployed, unfolded state. A reinforcing cloth 41 is attached on the rear portion and both sides of the air bag 26. The center of the reinforcing cloth 41 is located between the retainer 24 and the case 23 and is fixed on the inside of the air bag 26 by bolts 27. Both front ends of the reinforcing cloth 41 are sewn on respective foundation cloths 26a and 26b. Belts 41a extend downwardly and frontwardly from both sides of the center portion of front ends of the reinforcing cloth 41. Both belts 41a extend along the inside wall of the air bag 26, and both of the front ends of the belts 41a are sewn to a seamed front portion 29 of the air bag 26. The front ends of the belts 41a, overlap each other, are located between both of the foundation cloths 26a and 26b. The front ends of the belts 41a are sewn to the seamed front portion 29 of the air bag 26 with both of the foundation cloths 26a and 26b to form a seamed belt portion 36 below the inflator 25 in the direction of the hip region of the passenger P. The portions of the belts 41a that are sewn to the air bag 26 form a junction portion 41b.

The belts 41a are not sewn to the air bag 26 except at a boundary portion 41c of the reinforcing cloth 41 and the junction portion 41b. Only the boundary portion 41c and the junction portion 41b restrict movement of the air bag 26. Thus, a tensile force is added on the belts 41a between the seamed belt portion 36 and the boundary portion 41c when the air bag 26 is expanded. The tensile force restrains the seamed belt portion 36 toward the reinforcing cloth 41 fixed to the case 23 with the air bag 26.

Deployment of the side air bag device 22 will be explained referring FIGS. 4-6. The side air bag 26 is expanded at the side of the passenger P when the sensor of the vehicle detects the aforementioned side collision. At that time, the air bag 26 is expanded frontwardly and downwardly from the case 23. The lower portion (corresponding to the hip region of the passenger P) of the air bag 26 tends to expand in a declined frontward direction due to the force of the gas discharged from the inflator 25, so deviation from an intended expanded position may occur. The seamed belt portion 36, however, is pulled back toward the reinforcing cloth 41 by the tensile force added on the belts 41a when the air bag 26 is expanded. Thus, frontward deviation from the aforementioned intended position is restricted. The inner tube 40 conducts the gas discharged from the inflator 25 to the lower portion (corresponding to the hip region of the passenger P) of the air bag 26, thereby bypassing the hinge 30. As the inner tube 40 conducts the gas to the lower portion of the air bag 26 in a concentrated manner, the belts 41a restrict frontward deviation of the air bag 26 that would otherwise be caused by the gas.

The air bag device of the present invention according to the second embodiment includes the belts 41a to control the expanding position of the air bag 26. In addition, the gas discharged from the inflator 25 is quickly directed by the inner tube 40 to the lower portion of the air bag 26. As a result, the passenger P is preferably protected.

Because the belts 41a are sewn on the inside wall of the air bag 26, the belts 41a can preferably control the expanding position of the air bag 26 without other parts in the vehicle interfering with the expansion of the air bag.

Because the air bag 26 is formed to expand downwardly from the inflator 25, the lower portion of the air bag 26 tends to decline in a frontward manner due to the force of the expanded gas. However, because the seamed belt portion 36 is seamed downwardly near the hip region of the passenger P, the expanding position of the air bag 26 can be controlled preferably by the belts 41a when the air bag 26 is expanded.

Although there is a hinge between the inflator 25 and the lower portion of the air bag 26, the gas discharged from the inflator 25 is conducted by the inner tube 40 to the lower portion of the air bag 26 and therefore bypasses the hinge 30.

As will be appreciated by one skilled in the art, the above-mentioned embodiments of the present invention can be modified as follows. For example, in the first embodiment, the belt 28 can be sewn on the inside wall of the air bag 26. In the second embodiment, the belts 41a can be sewn on the surface of the air bag 26. Also, the inner tube 40 can be shortened from the length shown for example in FIG. 5.

In the first and second embodiments, the side air bag device 22 can alternatively be placed in the rear seat of the vehicle.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A side air bag device for expanding an air bag beside a passenger of a vehicle, comprising:
an air bag case for mounting in a vehicle seat back;
an air bag that is fixed in the case at a fixing portion and that is expandable in a frontward direction between a body side of the vehicle and the vehicle passenger seat, wherein the air bag includes a seamed belt portion located at one seamed front portion of the air bag; and
a belt sewn on the air bag at both the seamed belt portion and the air bag case,
wherein the belt is for creating a tensile force to pull back the seamed belt portion toward the fixing portion when the air bag is expanded.

2. A side air bag device according to claim 1, wherein the belt is sewn on the inside wall of the air bag.

3. A side air bag device according to claim 1, wherein the belt is sewn on the outer surface of the air bag.

4. A side air bag device according to claim 1, wherein the air bag is for protecting a head region and a thoracic region of the passenger when the air bag is expanded, and the seamed belt portion is located above the fixing portion in the direction of the head of the passenger when the air bag is expanded.

5. A side air bag device according to claim 1, wherein the air bag is for protecting a hip region and a thoracic region of the passenger when the air bag is expanded, and the seamed belt portion is located below the fixing portion in the direction of the hip region of the passenger when the air bag is expanded.

6. A side air bag device according to claim 5, wherein the air bag includes an inner tube for conducting gas to a portion of the air bag corresponding to the passenger hip region.

7. A side air bag device according to claim 1, further comprising a gas generator for generating gas.

8. A side air bag device according to claim 7, wherein the gas generator includes an inner tube for conducting gas to a portion of the air bag corresponding to the passenger hip region.

9. A side air bag device according to claim 3, wherein a length of the belt is no more than twice a distance between the seamed belt portion and the air bag case when the air bag is viewed in a non-deployed, unfolded state.

10. A side air bag device according to claim 1, wherein the belt is fixed to the air bag case with the air bag at a junction portion.

11. A vehicle passenger side air bag device, comprising:
an air bag case for mounting in a vehicle seat back;
a gas generator housed in the air bag case;
an air bag affixed to and housed in the air bag case, the air bag having at least one of an upwardly protruding shape and a downwardly protruding shape when the air bag is expanded and being expandable in a vehicle frontward from direction the vehicle seat back by gas discharged from the gas generator; and
a belt sewn on a portion of the air bag where the air bag is fixed and on a seamed front portion of the air bag, wherein the belt restricts frontward deviation from an intended direction of expansion of the air bag by a tensile force caused by the belt during expansion of the air bag.

12. A vehicle passenger side air bag device, comprising:
an air bag case for mounting in a vehicle seat back;
a gas generator housed in the air bag case;
an air bag affixed to and housed in the air bag case, the air bag having at least one of an upwardly protruding shape and a downwardly protruding shape when the air bag is expanded and being expandable in a vehicle frontward direction from the vehicle seat back by gas discharged from the gas generator; and
expansion restricting means for restricting frontward deviation from an intended direction of expansion of the air bag during air bag expansion.

13. A side air bag device according to claim 1, wherein the belt is made from the same material as the air bag.

14. A vehicle passenger side air bag device according to claim 11, wherein the belt is made from the same material as the air bag.

15. A vehicle passenger side air bag device according to claim 12, wherein the belt is made from the same material as the air bag.
